(19) United States
(12) Patent Application Publication
(10) Pub. No.: US 2023/0342537 A1
(43) Pub. Date: Oct. 26, 2023

(54) LAYOUT DESIGN METHOD, INTEGRATED CIRCUIT, OPERATION CHIP, AND COMPUTING DEVICE

(71) Applicant: SHENZHEN MICROBT ELECTRONICS TECHNOLOGY CO., LTD., GUANGDONG (CN)

(72) Inventors: Weixin KONG, GUANGDONG (CN); Dong YU, GUANGDONG (CN); Zhijun FAN, GUANGDONG (CN); Wenbo TIAN, GUANGDONG (CN)

(21) Appl. No.: 18/245,466

(22) PCT Filed: Jun. 24, 2021
(86) PCT No.: PCT/CN2021/101930

§ 371 Date: Mar. 15, 2023

(30) Foreign Application Priority Data
Nov. 30, 2020 (CN) 202011376998.7

(51) Int. Cl. G06F 30/398; G06F 30/392; G06F 30/394

(52) U.S. Cl. CPC G06F 30/398; G06F 30/392; G06F 30/394

(57) ABSTRACT

The present disclosure relates to a layout design method, an integrated circuit, an operation chip, and a computing device. The layout design method comprises generating a primary layout on the basis of a circuit diagram netlist by using a primary standard cell library, the circuit diagram netlist comprising a first standard cell and a second standard cell, and the primary standard cell library comprising a first standard layout of the first standard cell and a second standard layout of the second standard cell. The method further comprises consolidating the first standard layout and the second standard layout on the basis of a splicing relationship between the first standard layout and the second standard layout in the primary layout to optimize the consolidated layout.

### CROSS-REFERENCE TO RELATED APPLICATIONS

The present application is a U.S. National Phase Application of PCT/CN2021/101930, filed Jun. 24, 2021, which is based on and claims priority to Chinese Patent Application No. 202011376998.7 filed on Nov. 30, 2020, which is incorporated herein in its entirety.

### TECHNICAL FIELD

The present disclosure relates to the field of System on Chip design, and specifically, to a layout design method, an integrated circuit, an operation chip, and a computing device.

### BACKGROUND

In the field of System on Chip design, semi-customized design is increasingly becoming a prominent style of layout design due to its reduced time and labor costs. Standard cell method, as an important technology in semi-customized design, refers to the design of some basic logic functions into spliceable cells according to some principles such as equal height and variable width. In general, semiconductor foundries or third-party IP providers can provide primary standard cell libraries for specific processes.

### SUMMARY

According to a first aspect of the present disclosure, a method is provided. The method includes: generating a primary layout based on a circuit diagram netlist using a primary standard cell library, the circuit diagram netlist comprising a first standard cell and a second standard cell, and the primary standard cell library comprising a first standard layout of the first standard cell and a second standard layout of the second standard cell; and consolidating the first standard layout and the second standard layout based on a splicing relationship between the first standard layout and the second standard layout in the primary layout to optimize the consolidated layout.

In some embodiments, the second standard layout is a standard layout in the primary layout that has a frequency of splicing with the first standard layout higher than a reference value.

In some embodiments, a layout area of at least one standard layout of the first standard layout or the second standard layout is greater than a theoretical minimum of the layout area of the at least one standard layout, and the consolidating the first standard layout and the second standard layout to optimize the consolidated layout comprises: reducing an area of the consolidated layout of the first standard layout and the second standard layout.

In some embodiments, the consolidating the first standard layout and the second standard layout to optimize the consolidated layout comprises: identifying a potentially optimizable region in the at least one standard layout of the first standard layout or the second standard layout; determining, based on the splicing relationship between the first standard layout and the second standard layout, whether the first standard layout and the second standard layout have restrictions on the potentially optimizable region; determining, in response to determining that the first standard layout and the second standard layout have no restrictions on the potentially optimizable region, that the potentially optimizable region is an optimizable region; and adjusting a layout of the at least one standard layout comprising the optimizable region to reduce an area of the optimizable region.

In some embodiments, the at least one standard layout is implemented based on MOS transistors, and the consolidating the first standard layout and the second standard layout to optimize the consolidated layout comprises: transferring connection relationships on redundant gate polysilicon in the at least one standard layout to other appropriate gate polysilicon and removing the redundant gate polysilicon.

In some embodiments, the consolidating the first standard layout and the second standard layout to optimize a consolidated layout comprises: reducing lengths of interconnections in subsequent routing.

In some embodiments, the reducing the lengths of interconnections in subsequent routing further comprises: adjusting interconnections between the first standard layout and the second standard layout that is obtained through automatic routing and that is at a different metal layer from interconnections in the first standard layout or the second standard layout to a same metal layer as the interconnections in the first standard layout or the second standard layout.

In some embodiments, the method further comprises splitting the optimized consolidated layout into a first optimized layout for the first standard cell and a second optimized layout for the second standard cell; and adding the first optimized layout and the second optimized layout to the primary standard cell library to form an optimized standard cell library.

In some embodiments, the first optimized layout comprises information for indicating that the first optimized layout needs to be used in combination with the second optimized layout in a layout design, and the second optimized layout comprises information for indicating that the second optimized layout needs to be used in combination with the first optimized layout in a layout design.

In some embodiments, the first standard layout, the second standard layout, and the optimized consolidated layout meet process design rules.

According to a second aspect of the present disclosure, an integrated circuit is provided. The integrated circuit includes: a first standard cell; and a second standard cell, a first layout of the first standard cell and a second layout of the second standard cell have a splicing relationship, the first layout is obtained by adjusting a layout of a first standard layout of the first standard cell in a primary standard cell library, and the second layout is a second standard layout of the second standard cell in the primary standard cell library or is obtained by adjusting a layout of the second standard layout of the second standard cell in the primary standard cell library, such that a sum of areas of the first layout and the second layout is less than a sum of areas of the first standard layout and the second standard layout.

In some embodiments, the first standard cell and the second standard cell are implemented based on CMOS transistors, adjusting the layout of the first standard layout or adjusting the layout of the second standard layout comprises transferring connection relationships on redundant gate polysilicon in the first standard layout or second standard layout to other appropriate gate polysilicon and removing the redundant gate polysilicon.

In some embodiments, the first standard cell and the second standard cell are two-input Exclusive-OR gates (XOR2s), and the integrated circuit is an adder circuit.

According to a third aspect of the present disclosure, an operation chip is provided, including at least one integrated circuit as described above.

According to a fourth aspect of the present disclosure, a computing device is provided. The computing device is configured to execute an algorithm for mining virtual digital currency, and includes: at least one operation chip as described above, a control chip, a power supply module and a heat dissipater, the control chip is coupled to the at least one operation chip and configured to control an operation of the at least one operation chip, the power supply module is configured to provide power to the at least one operation chip and/or the control chip, and the heat dissipater is configured to dissipate heat for the at least one operation chip, the control chip, and/or the power supply module.

Other characteristic features and advantages of the present disclosure become apparent based on the following descriptions with reference to the accompanying drawings.

### BRIEF DESCRIPTION OF THE DRAWINGS

The accompanying drawings are for illustrative purposes and are used only to provide examples of possible structures and arrangements of the inventive apparatus and methods of applying the same to a computing device disclosed herein. The accompanying drawings in no way limit any changes in form and details that may be made to the embodiments by a person skilled in the art without departing from the spirit and scope of the embodiments. The described embodiments are more easily understood through the following detailed descriptions with reference to the accompanying drawings, where similar reference numerals indicate similar structural elements.

FIG. 1 is a flowchart of a layout design method in accordance with embodiments of the present disclosure.

FIG. 2 is a circuit diagram of a two-input Exclusive-OR gate (XOR2) standard cell.

FIG. 3 shows a standard layout of an XOR2 standard cell in a standard cell library.

FIG. 4A shows a primary layout generated when both a first standard cell and a second standard cell are XOR2s implemented based on CMOS transistors.

FIG. 4B shows a layout obtained by consolidating and optimizing the primary layout in FIG. 4A in accordance with embodiments of the present disclosure.

FIG. 5A is a circuit diagram where a two-input NAND gate (NAND2) standard cell and an XOR2 standard cell are connected.

FIG. 5B is a schematic diagram of consolidating and optimizing an NAND2 standard layout and an XOR2 standard layout that are spliced in accordance with embodiments of the present disclosure.

FIG. 6 is a schematic diagram of splitting an optimized consolidated layout in accordance with embodiments of the present disclosure.

FIG. 7 is a schematic diagram of an operation chip and a computing device in accordance with embodiments of the present disclosure.

It should be noted that, in the implementations described below, the same reference numerals are used in common between different drawings to denote the same parts or parts having the same function, and repeated descriptions thereof are omitted. In this specification, similar numerals and letters are used to indicate similar items. Therefore, once an item is defined in an accompanying drawing, the item does not need to be further discussed in the subsequent accompanying drawings.

For ease of understanding, positions, sizes, ranges, and the like of each structure shown in the accompanying drawings and the like may not represent actual positions, sizes, ranges, and the like. Therefore, the disclosed invention is not limited to the positions, sizes, ranges, and the like disclosed in the accompanying drawings and the like. In addition, the accompanying drawings are not necessarily drawn to scale and some features may be exaggerated to show details of particular components.

### DETAILED DESCRIPTION

Various exemplary embodiments of the present disclosure are described in detail below with reference to the accompanying drawings. It is to be noted that, unless otherwise specified, the relative deployment, the numerical expression, and values of the components and steps described in the embodiments do not limit the scope of the present disclosure.

The following descriptions of at least one exemplary embodiment are actually merely illustrative, and in no way limit the present disclosure and application or use of the present disclosure. In other words, the structures and methods herein are shown exemplarily, to illustrate different embodiments of the structures and methods in the present disclosure, and are not intended to be limiting. A person skilled in the art should understand that the descriptions merely illustrate exemplary, but not exhaustive, manners in which the present disclosure may be implemented. In addition, the accompanying drawings are not necessarily to scale and some features may be exaggerated to show details of particular components.

Technologies, methods, and devices known to a person of ordinary skill in the art may not be discussed in detail, but in proper circumstances, the technologies, the methods, and the devices shall be regarded as a part of this specification as allowed.

As described above, in the existing System on Chip (SoC) layout design based on standard cells, a primary standard cell library provided by a third party is generally used. However, standard cells in such a primary standard cell library are often designed to take into account the requirements of many different customers. For a specific design project, the layout design using such standard cells is not optimal in terms of area, power consumption, speed, and the like. Specifically, the design using such a primary standard cell library is often based on different requirements of many users and comprehensively considers scenarios of splicing corresponding standard cells with various other cells/modules/devices. As a result, a layout designed with such a primary standard cell library may ensure that process design rules can still be met in some extreme or special cases, but usually has certain redundancy in terms of performance such as area, power consumption, speed, and the like.

Therefore, when the layout design based on the primary standard cell library is performed for a specific chip, optimization may be required to seek improvements in area, power consumption, speed, and the like.

In view of this, the present disclosure provides an improved layout design method based on a primary standard cell library. In a specific project, a splicing relationship between standard layouts of standard cells in the primary standard library is inspected, and the standard layouts of two or more standard cells are consolidated and optimized, thereby making improvements in terms of area, power consumption, speed, and the like compared to designing simply based on standard layouts. Further, an optimized consolidated layout may be split into optimized layouts for corresponding standard cells and added to the primary standard cell library to form an optimized standard cell library. In a subsequent layout design, based on a determined splicing relationship between standard cells, optimized layouts corresponding to the standard cells in the optimized standard cell library can be directly used, thereby improving the efficiency and quality of the layout design. Specific embodiments according to the present disclosure are described below in detail.

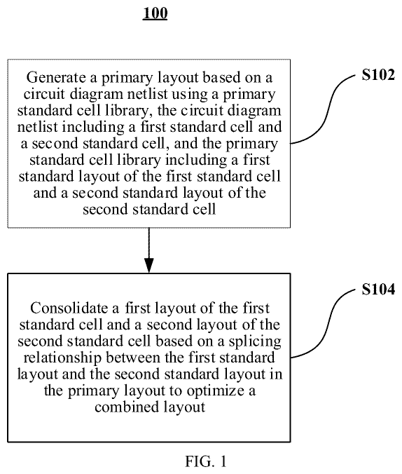

FIG. 1 is an exemplary flowchart of a layout design method 100 in accordance with embodiments of the present disclosure. The method 100 may be implemented by a computer device.

As shown in FIG. 1, at step S102, a primary layout may be generated by the computer device based on a circuit diagram netlist using a primary standard cell library, the circuit diagram netlist including a first standard cell and a second standard cell, and the primary standard cell library including a first standard layout of the first standard cell and a second standard layout of the second standard cell.

The circuit diagram netlist is a logical description of an application specific integrated circuit (ASIC) generated based on a circuit schematic. The circuit diagram netlist may describe interconnection between modules in an integrated circuit chip, logical units in the modules, and connectors of the logical units. A logical unit is a circuit unit that completes a complete logical function, and may include a standard cell or a non-standard cell. In some embodiments, the circuit diagram netlist may include only standard cells, connectors thereof, and information about interconnection between modules formed by the standard cells, without involving non-standard cells. In some other embodiments, if the circuit diagram netlist involves non-standard cells, the primary layout may be generated only for the standard cells in the circuit diagram netlist at step S102.

A standard cell is a pre-designed logical block with some circuit logic functions. The standard cell may have a corresponding circuit diagram and a corresponding layout. In a non-limiting example, a standard cell may include inverters, AND gates, NAND gates, NOR gates, registers, flip-flops, and the like.

A primary standard cell library is a collection of associated design information provided by a foundry or third-party IP provider to describe standard cells. Within the scope of the present disclosure, the primary standard cell library may include at least a layout library for standard cells. The first standard layout and the second standard layout are layouts for the first standard cell and the second standard cell respectively in the layout library of the primary standard cell library. Further, the primary standard cell library may further include one or more of a cell symbol library, a layout routing library, a synthesis library, a simulation library, a timing library, and the like.

At step S102, a mapping from the standard cells in the circuit diagram netlist to layouts of the standard cells may be formed by the computer device using the primary standard cell library. Specifically, in some embodiments, forming such a mapping may include: searching the primary standard cell library for standard layouts corresponding to the standard cells in the circuit diagram netlist, and determining positions of the standard layouts in the primary layout based on layout rules.

In the primary standard cell library, the standard layouts corresponding to the standard cells meet the process design rules. The process design rules are a set of limitations to geometric sizes of the same process layer and between different process layers according to the actual process level (including lithography characteristics, etching capabilities, alignment tolerance, and the like) and yield requirements under the condition of normal operation of devices, and mainly include rules of line width, pitch, coverage, outcrop, notch, area, and the like, whose minimums are given respectively to prevent a designed mask pattern from breaking, connecting, or having some adverse physical effects. In summary, the process design rules may include width rules, pitch rules, and overlapping rules.

Taking a Positive Channel Metal Oxide Semiconductor (PMOS) transistor or a Negative Channel Metal Oxide Semiconductor (NMOS) transistor as an example, process design rules therefor may include specifying: (1) a minimum width and a minimum pitch of an N-trap layer, a size of N-trap covering P-type injected active area inside the N-trap, a distance between the N-trap and N-type injected active area outside N-trap, and the like; (2) a width and a pitch of P-type active area and N-type active area, and the like; (3) a minimum width and a pitch of a polysilicon (Poly) layer, a minimum outer distance between the polysilicon and the active area, a distance of the polysilicon protruding from the active area, a minimum inner distance between the polysilicon and the active area, and the like; (4) a size and a pitch of a contact hole, a size of a polysilicon cover hole, a size of an active area cover hole, a distance between an active area hole and a grid, a distance between a polysilicon hole and an active area, a size of a metal cover hole, and the like; (5) a width and a pitch of a metal in a metal connecting wire; (6) a minimum size of a pad, a minimum edge pitch of the pad, a minimum metal covering size of the pad, a minimum distance from outside the pad to the active area, and the like.

During designing of a standard layout in the primary standard cell library, the strictest standards are used for the limitation to the geometric size of the standard layout to enable the standard cell to meet the process design rules when spliced with different devices. For example, in some cases, the width of the standard layout may be increased to increase a distance between a critical pattern (for example, the metal connecting wire) and a layout boundary. In some embodiments, at least one of the first standard layout or the second standard layout has a layout width/area greater than a theoretical minimum of the layout width/area thereof. The theoretical minimum of the layout width/area may be the minimum layout width/area that the layout can achieve in a case that the layout meets the process design rules and can implement the circuit logic function. It should be noted that since a standard layout follows the design principle of equal height and variable width, the width of the layout directly determines the area of the layout. Unless otherwise specified, both the layout width and the layout area are used interchangeably herein.

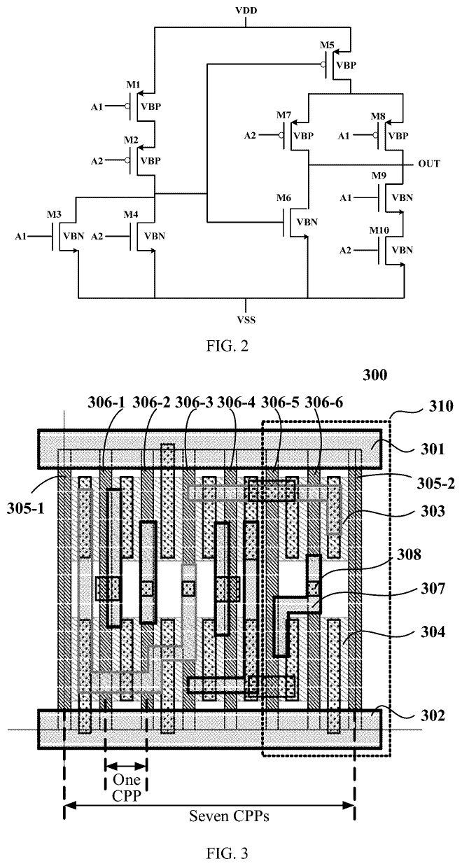

This design redundancy for the standard layouts in the primary standard cell library is described below by taking FIG. 2 and FIG. 3 as examples. FIG. 2 is a circuit diagram of an XOR2 standard cell. FIG. 3 shows a standard layout 300 for the XOR2 in FIG. 2 in the existing primary standard cell library.

In FIG. 2, five PMOS transistors (M1, M2, M5, M7, and M8) and five NMOS transistors (M3, M4, M6, M9, and M10) are used, that is, five pairs of MOS transistors. Gates of the MOS transistors M1, M3, M8, and M9 are connected to a first input A1, and gates of the MOS transistors M2, M4, M7, and M10 are connected to a second input A2. Sources of the PMOS transistors M1 and M5 are connected to a power supply VDD, and sources of the NMOS transistors M3, M4, M6, and M10 are grounded to VSS.

In theory, for such a circuit diagram, it is sufficient to use five lines of polysilicon as gates in the layout, and adding two lines of dummy polysilicon as isolation boundaries on the left and right respectively, a cell width of the formed layout should be a contacted polysilicon pitch (CPP) of six lines of gate polysilicon with contact holes. The CPP is the minimum center distance between two lines of gate polysilicon and is an important indicator used for measuring the width of a standard cell. That is, the theoretical minimum width of the layout of such an XOR2 circuit is six CPPs.

In FIG. 3, the layout 300 includes a power supply bus 301, a ground bus 302, a P-type injected active area 303, an N-type injected active area 304, a dummy polysilicon 305 (for simplicity, boundary polysilicon 305-1 and 305-2 are collectively referred to as the dummy polysilicon 305 herein), a gate polysilicon 306 (for simplicity, gate polysilicon 306-1, 306-2, . . . , and 306-6 are collectively referred to as the gate polysilicon 306), a metal connecting wire 307, and a contact hole (including a via hole) 308. It can be seen that the layout 300 uses six lines of polysilicon of 306-1, 306-2, . . . , and 306-6 as gates, increasing the cell width to seven CPPs. The reason is that, although only five gate polysilicon (306-1 to 306-5) are theoretically required, metal connecting wires and contact holes on the fifth gate polysilicon (that is, the gate polysilicon 306-5) need to be moved toward the boundary to meet the process design rule. As a result, the metal connecting wires and contact holes are too close to the boundary. To reduce problems during splicing with some devices, in a boundary region 310 shown in the dashed box in FIG. 3, the standard layout 300 partially transfers the connection relationship of the fifth gate polysilicon to the added gate polysilicon (that is, the gate polysilicon 306-6) through interconnection, where metal connecting wires and via holes on the added gate polysilicon may be at a greater distance from the boundary. From the perspective of circuit logic function, the added polysilicon is redundant. This is because theoretically only five lines of gate polysilicon are needed to implement the circuit logic function. The added gate polysilicon causes the width/area of the existing standard layout 300 to be greater than the theoretical minimum (six CPPs). Therefore, the layout 300 can meet the process design rules when adjacent to layouts of various devices, but at the expense of the cell width/area performance.

Still referring to FIG. 1, at step S102, in some embodiments, a position of each standard layout in the primary layout is determined by the computer device based on layout rules after the corresponding standard layout is found from the primary standard cell library. The layout rules may specify an optimal position of each layout on the chip to reduce the footprint and improve a routing result. The layout rules may be preset artificially or formulated based on some existing layout algorithms (for example, based on minimum cut or enumeration).

At step S104, based on a splicing relationship between the first standard layout and the second standard layout in the primary layout, the first standard layout is consolidated with the second standard layout by the computer device to optimize the consolidated layout.

After the primary layout is generated at step S102, positions of the first standard layout and the second standard layout in the primary layout may be determined to determine whether the two layouts have a splicing relationship. Two layouts having a splicing relationship may indicate that the two layouts are adjacent on the boundary. In some embodiments, that the first standard layout and the second standard layout have a splicing relationship may include that the first standard layout and the second standard layout are placed adjacent to each other because the first standard cell corresponding to the first standard layout and the second standard cell corresponding to the second standard layout are functionally related and/or connected in an electrical port. For example, circuit implementation of an adder includes two connected XOR2s. The two XOR2s are functionally related and connected. Therefore, when layout rules are used to determine positions of two XOR2s in the primary layout, layouts of the two XOR2s are often placed adjacent to each other. In some other embodiments, the first standard cell and the second standard cell may not be functionally related or connected in the electrical port, and are only adjacent in the layout position.

After it is determined that the first standard layout and the second standard layout have a splicing relationship in the primary layout, the first standard layout may be consolidated with the second standard layout based on the splicing relationship, and the consolidated layout is optimized.

Consolidating the first standard layout and the second standard layout may include combining the first standard layout and the second standard layout as a whole for consideration. The optimization of the consolidated layout may include various optimizations that can be made by layout designers in the art based on experience or various known algorithms in layout design to improve the chip area, the power consumption, the speed, and the like. In some embodiments, optimizing the consolidated layout may include at least one of the following: (1) reducing the width/area of the consolidated layout; or (2) reducing lengths of interconnections in subsequent routing.

In terms of optimizing by reducing the width/area of the consolidated layout, in some embodiments, the consolidating the first standard layout and the second standard layout to optimize a consolidated layout may include: first, identifying a potentially optimizable region in at least one of the first standard layout or the second standard layout. The potentially optimizable region may be a region in the standard layout that makes the width/area of the layout greater than a theoretical optimal width/area thereof. For example, a potentially optimizable region of the layout 300 is the boundary region 310 in FIG. 3. This is because this region causes the area/width of the layout to be greater than the theoretical minimum. There may be one or more potentially optimizable regions. Further, when the at least one standard layout of the first standard layout and the second standard layout is implemented based on MOS transistors, the potentially optimizable region may be a region including a gate polysilicon redundant with respect to the circuit logic function of the standard layout.

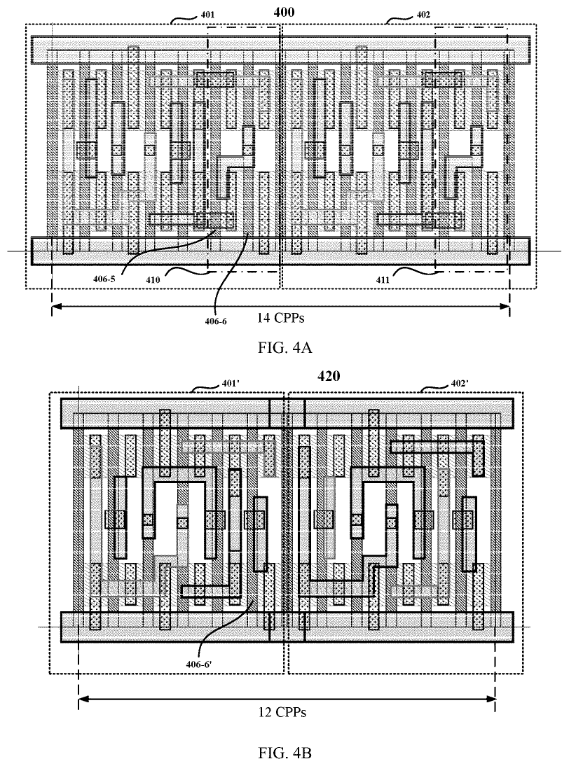

Based on the first standard layout and the second standard layout being spliced, it can be determined whether the second standard layout has restrictions on the potentially optimizable region of the first standard layout, so that it can be determined whether the potentially optimizable region is actually optimizable. The restrictions mean that if the potentially optimizable region is optimized, the first or second standard layout has difficulty meeting the process design rules. If it is determined that the second standard layout has no restriction on the potentially optimizable region of the first standard layout, it can be determined that the potentially optimizable region is actually optimizable. Conversely, it can also be determined whether the first standard layout has restrictions on the potentially optimizable region of the second standard layout, so that it can be determined whether the potentially optimizable region is actually optimizable. For example, as described in detail below with reference to FIG. 4B, since the two XOR2s are spliced, and one XOR2 has no particular requirement for the width of the boundary region of the other XOR2, it can be determined that the potentially optimizable region of the XOR2 (for example, the boundary region 310 in FIG. 3) is actually optimizable under such splicing relationship. In another example, if the potentially optimizable region of one standard layout of the two standard layouts is close to the boundary of the two standard layouts, and the other standard layout has an out-of-boundary component (for example, a metal connecting wire), optimizing the potentially optimizable region would make it difficult for the two standard layouts to meet the process design rules. Therefore, the potentially optimizable region can be determined to be non-optimizable.

After it is determined that the potentially optimizable region is an optimizable region, the consolidated layout of the first standard layout and the second standard layout can be optimized. To reduce the width/area of the consolidated layout, means for implementing the optimization may include adjusting a layout of the first or second standard layout including the optimizable region to reduce the width/area of the optimizable region. For example, positions of various components (including gate layers, active area layers, contact hole/via hole layers, pad layers, N-trap layers, and the like) and interconnection (metal connecting wires) in the standard layout may be adjusted. Further, when the standard layout with the optimizable region is implemented based on MOS transistors, the means for implementing the optimization may include transferring the connection relationship (including components such as metal connecting wires and contact holes) of the redundant gate polysilicon in the optimizable region to other appropriate components (for example, other appropriate gate polysilicon), and removing the redundant gate polysilicon. Since the width/area of the layout is determined based on the quantity of the gate polysilicon (that is, the quantity of CPPs), removing the gate polysilicon can reduce the width/area.

In terms of optimizing by reducing the lengths of interconnections in subsequent routing, in some embodiments, the consolidating the first standard layout and the second standard layout to optimize a consolidated layout may include: automatically routing the first standard layout and the second standard layout by using an existing automatic routing algorithm, identifying that the interconnection between the first standard layout and the second standard layout after the automatic routing is at a different metal layer from the interconnection between the components in the first standard layout or the second standard layout, and adjusting the interconnection between the first standard layout and the second standard layout to a same metal layer as the interconnection between the components in the first standard layout or the second standard layout. Therefore, routing resources on other metal layers can be saved, or the quantity of metal layers can be reduced, thereby reducing the length of interconnection between the metal layers and improving the processing speed of the chip.

In some embodiments, the optimized consolidated layout can meet the process design rules. In this way, the final chip layout can be designed based on the consolidated layout, and a corresponding data file according to which the chip manufacturer can manufacture the chip can be generated.

In some embodiments, the second standard layout may be any standard layout in the primary layout that has a splicing relationship with the first standard layout. In a further embodiment, the second standard layout may be a standard layout in the primary layout that has a frequency of splicing with the first standard layout higher than a reference value. The reference value may be an artificially preset threshold or a frequency of the first standard layout splicing with another standard layout in the primary layout. Whether there is a splicing relationship between all standard layouts including the first standard layout and the second standard layout in the primary layout may be analyzed, and a frequency of the splicing may be counted. If the frequency at which the first standard layout and the second standard layout are spliced in the primary layout is relatively high, for example, higher than an artificially preset threshold or higher than a frequency at which the first standard layout and another standard layout is spliced, the second standard layout and the first standard layout are consolidated and optimized. In this way, greater improvements in the overall performance of the chip design can be achieved at a lower design cost by consolidating and optimizing standard cells with a higher frequency of splicing.

An implementation of consolidating and optimizing layouts in accordance with embodiments of the present disclosure is described below with reference to FIG. 4A and FIG. 4B by taking XOR2s as an example.

FIG. 4A shows a primary layout 400 generated when both a first standard cell and a second standard cell are XOR2s implemented based on CMOS transistors. The first standard layout 401 and the second standard layout 402 has a splicing relationship. The first standard layout 401 is the same as the standard layout 300 in FIG. 3 except for a position where the first standard layout is spliced with the second standard layout 402. Similarly, the second standard layout 402 is the same as the standard layout 300 in FIG. 3 except for a position where the second standard layout is spliced with the first standard layout 401. For the splicing position, it may be considered that the first standard layout 401 is obtained by cutting the dummy polysilicon 305-2 of the standard layout 300 in FIG. 3 from the middle, leaving only the left part, and the second standard layout 402 is obtained by cutting the dummy polysilicon 305-1 of the standard layout 300 in FIG. 3 from the middle, leaving only the right part. The first standard layout 401 and the second standard layout 402 are then spliced. That is, a so-called single diffusion break (SDB) technology is used. In this way, the width of the formed primary layout 400 in FIG. 4A is 14 CPPs. In contrast, if a double diffusion break (DDB) technology is used, that is, compared to the standard layout of the single XOR2 in FIG. 3, no dummy polysilicon at the boundary is cut for the first standard cell and the second standard cell during splicing, the formed primary layout 400 has a width greater than 14 CPPs.

FIG. 4B shows a layout 420 obtained by consolidating and optimizing the first standard layout 401 and the second standard layout 402. As described above, in the first standard layout 401, to increase the distance between the metal connecting wire and the boundary, redundant gate polysilicon 406-6 is added in the boundary region 410, and connection relationships of the gate polysilicon 406-5 are at least partially transferred to the redundant gate polysilicon 406-6. This is the same for a boundary region 411 in the second standard layout 402. The boundary regions 410 and 411 are potentially optimizable regions. Moreover, in a case that the layouts 401 and 402 are two XOR2 and are spliced, the layout 402 has no particular requirements for the boundary region 410 of the layout 401, and there is no need to intentionally increase the distance between the metal connecting wire in the boundary region and the boundary, so that the boundary region 410 may be optimized. For example, the layout of the boundary region 410 may be adjusted. Specifically, the connection relationships (including elements such as metal connecting wires and contact holes) on the redundant gate polysilicon 406-6 is restored to the gate polysilicon 406-5 through transferring, so that the redundant gate polysilicon 406-6 can be removed to obtain a first optimized layout 401′. The region 411 may be optimized by using the same method to obtain a second optimized layout 402′. In this way, the width of the optimized consolidated layout 420 is 12 CPPs. Compared to 410, the area of the optimized consolidated layout is saved by 14.3%.

It is worth pointing out that although FIG. 4B shows only one redundant gate polysilicon as an example, it should be noted that in standard layouts of some standard cells, there may be a plurality of redundant gate polysilicon. At least a part of the plurality of redundant gate polysilicon may be optimized, including: transferring connection relationships thereof to other appropriate gate polysilicon and removing the redundant gate polysilicon. In addition, although FIG. 4B shows optimization of both the first standard layout and the second standard layout, in some other embodiments, only one of the two layouts may be alternatively optimized, which can still save the area to a certain extent.

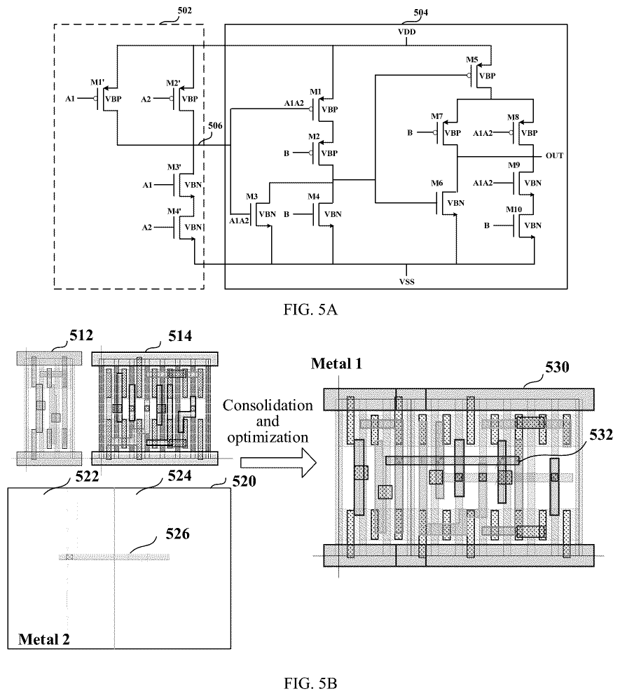

Another implementation of consolidating and optimizing layouts in accordance with embodiments of the present disclosure is described below with reference to FIG. 5A and FIG. 5B. FIG. 5A is a circuit diagram where two standard cells, a two-input NAND gate (NAND2) and a two-input Exclusive-OR gate (XOR2), are connected. FIG. 5B is a schematic diagram of consolidating and optimizing an NAND2 standard layout and an XOR2 standard layout that are spliced.

As shown in FIG. 5A, a circuit diagram 502 of the NAND2 standard cell produces a result of the AND of the inputs A1 and A2 at an output port 506. An output A1A2 of the NAND2 standard cell is connected to one of the two inputs of the XOR2 standard cell 504. A circuit diagram of the XOR2 standard cell may be the same as the circuit diagram in FIG. 2.

In FIG. 5B, a layout 512 in the standard cell library is a standard layout corresponding to the NAND2 standard cell in FIG. 5A, and a layout 514 in the standard cell library is a standard layout corresponding to the XOR2 standard cell in FIG. 5A. When the existing automatic routing algorithm is used for automatic routing, each standard layout is considered as a minimum complete cell without changing connections of metal layers (for example, a metal layer 1 (Metal 1)) used by each standard layout. Therefore, as shown in a metal layer 2 (Metal 2) view 520, the connection from the output of the NAND2 to the input of the XOR2 is implemented in the Metal 2 using a metal connecting wire 526 after the automatic routing. In the Metal 2 view 520, the layouts 512 and 514 are not shown in detail, and are only illustrated as boxes 522 and 524. The metal connecting wire 526 crosses the boxes 522 and 524.

The layout 512 and the layout 514 can be consolidated and optimized to reduce the lengths of interconnections in the subsequent routing according to the method in the embodiments. As shown in an optimized consolidated layout 530, the connection from the output of the NAND2 to the input of the XOR2 is transferred to the Metal 1 and achieved using a metal connecting wire 532. Therefore, the metal connecting wire 526 on the Metal 2 is not required any more. Therefore, routing resources on the Metal 2 can be saved, and the length of interconnection between the metal layers can be reduced, thereby improving the processing speed of the chip. The consolidated layout 530 added with the metal connecting wire 532 in the Metal 1 can meet the process design rules.

After the optimized consolidated layout is obtained, the method according to the embodiments of the present disclosure (for example, the method 100 in FIG. 1) may further include: splitting the optimized consolidated layout into a first optimized layout for the first standard cell and a second optimized layout for the second standard cell. The splitting may be performed based on ensuring the functional integrity of the first standard cell and the second standard cell. That is, circuit logic functions of the first optimized layout after the splitting and the first standard layout before the consolidation may be substantially the same, and similarly, circuit logic functions of the second optimized layout after the splitting and the second standard layout before the consolidation may be substantially the same. In some embodiments, at least one of the first optimized layout for the first standard cell or the second optimized layout for the second standard cell may not meet the process design rules.

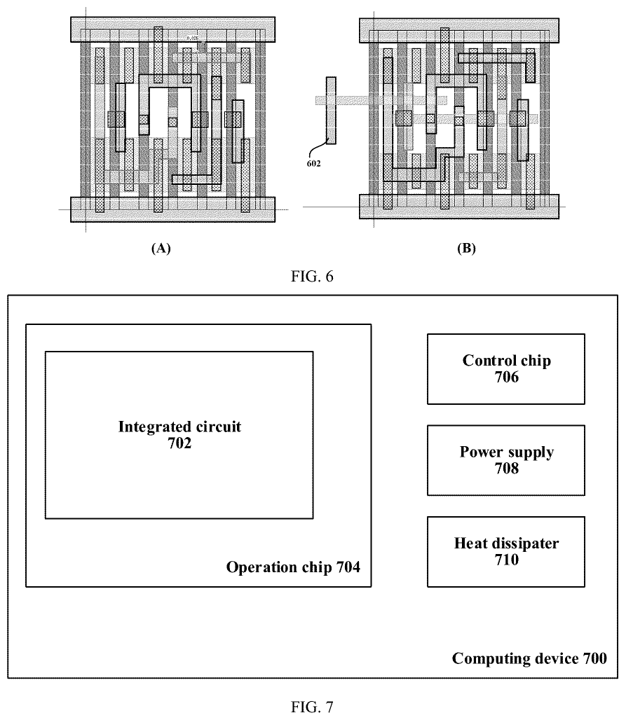

The splitting of the optimized consolidated layout is described below with reference to FIG. 6. FIG. 6 takes the optimized consolidated layout 420 in FIG. 4B as an example. As shown in FIG. 6, the consolidated layout 420 is split into two XOR2 optimized layouts on the left and right respectively. The left XOR2 optimized layout (A) corresponds to a region 401′ in FIG. 4B, and the right XOR2 optimized layout (B) substantially corresponds to a region 402′ in FIG. 4B. A circuit logic function corresponding to the layout (A) is still the XOR2, which is the same as the circuit logic function of the layout 401 in FIG. 4A; and a circuit logic function corresponding to the layout (B) is also still the XOR2, which is the same as the circuit logic function of the layout 402 in FIG. 4A. It is worth noting that a metal connecting wire 602 is beyond the boundary in the layout (B). Therefore, the right XOR2 optimized layout (B) does not meet the process design rules. The right XOR2 optimized layout may not pass the design rule check (DRC) verification when being used alone. However, when the left XOR2 optimized layout (A) is used in combination with the right XOR2 optimized layout (B), the process design rules are met. Although the metal connecting wire beyond the boundary in layout (B) is caused by the connection of the right XOR2 and the left XOR2 at a port, it should be noted that in some other examples, even if the first standard cell is not connected to the second standard cell, the first optimized layout or the second optimized layout split from the optimized consolidated layout thereof may still have a design rule violation in a case that there is a splicing relationship between the standard layouts thereof.

It should be noted that although FIG. 6 uses the splitting of the two XOR2s as an example, the splitting method for the optimized consolidated layout according to the present disclosure is applicable to other standard cells, as long as the circuit logic functions of the optimized layouts after the splitting is substantially the same as the circuit logic functions of the standard layouts before the combination.

After the first optimized layout and the second optimized layout are obtained, the method according to the embodiments of the present disclosure (for example, the method 100 in FIG. 1) may further include: adding the first optimized layout and the second optimized layout to the primary standard cell library to form an optimized standard cell library. The first optimized layout may be associated with the circuit diagram or the circuit diagram netlist of the first standard cell, and the second optimized layout may be associated with the circuit diagram or the circuit diagram netlist of the second standard cell. The first optimized layout may include information for indicating that the first optimized layout needs to be used in combination with the second optimized layout in a layout design, and the second optimized layout may include information for indicating that the second optimized layout needs to be used in combination with the first optimized layout in a layout design. Therefore, in a subsequent layout design, if the first standard cell is included in the circuit diagram netlist, the first optimized layout may be first retrieved from the optimized standard cell library; it is then determined, based on the information for indicating that the first optimized layout needs to be used in combination with the second optimized layout in a layout design, (1) whether the circuit diagram netlist includes the second standard cell corresponding to the second optimized layout and (2) whether the layout of the second standard cell has a splicing relationship with the layout of the first standard cell; and it is further determined whether to use the first optimized layout and the second optimized layout simultaneously. If there is no second standard cell, or the second standard cell has no splicing relationship with the first standard cell, the first optimized layout may not used. Using the optimized standard cell library for the subsequent layout design can greatly reduce the costs of the subsequent layout design and improve the design efficiency and quality.

The method according to the embodiments of the present disclosure (for example, the method 100 in FIG. 1) may further include: respectively characterizing the first optimized layout and the second optimized layout. Characterizing an optimized layout may include performing circuit extraction on the optimized layout, an extracted circuit diagram including parasitic resistance and parasitic capacitance elements in the layout; and simulating the extracted circuit diagram to determine delay characteristics of a standard cell corresponding to the layout. The determined delay characteristics may be used for subsequent timing verification of a designed chip.

It should be noted that only the case of including two standard cells is illustrated herein for ease of description. However, a person skilled in the art should understand that the method of the present disclosure can be extended to a plurality of standard cells for consolidation and optimization. When considering consolidating and optimizing a plurality of standard cells, the layout design method according to the present disclosure may be used between at least two of the standard cells.

A person skilled in the art should understand that although the concept of the present disclosure is described above in conjunction with a combination of two XOR2s, this combination is not intended to constitute any limitation to the concept of the present disclosure. The concept of the present disclosure can be applied to any known standard cell and combinations thereof.

In accordance with embodiments of the present disclosure, an integrated circuit may be provided, including a first standard cell and a second standard cell, where a first layout of the first standard cell and a second layout of the second standard cell have a splicing relationship, the first layout is obtained by adjusting a layout of a first standard layout of the first standard cell in a primary standard cell library, and the second layout is a second standard layout of the second standard cell in the primary standard cell library or is obtained by adjusting a layout of the second standard layout of the second standard cell in the primary standard cell library, so that a sum of areas of the first layout and the second layout is less than a sum of areas of the first standard layout and the second standard layout. The integrated circuit may be configured to implement relatively simple data processing functions, which may be, for example, an adder or a multiplier.

In some embodiments, the first standard cell and the second standard cell may be implemented based on CMOS transistors. The first layout is obtained by transferring connection relationships on redundant gate polysilicon in the first standard layout to other appropriate gate polysilicon in the first standard layout and removing the redundant gate polysilicon in the first standard layout, and the second layout is the second standard layout or is obtained by transferring connection relationships on redundant gate polysilicon in the second standard layout to other appropriate gate polysilicon in the second standard layout and removing the redundant gate polysilicon in the second standard layout.

In some embodiments, the first standard cell and the second standard cell may be XOR2s. A person skilled in the art should understand that the circuits and/or chips according to the present disclosure may be implemented by using a hardware description language (HDL) such as Verilog or VHDL. HDL descriptions may be synthesized for a cell library designed through a given integrated circuit manufacturing technology and modified for timing, power, and other reasons to obtain a final design database. The final design database may be transferred to a factory to produce integrated circuits by using a semiconductor manufacturing system. The semiconductor manufacturing system may produce integrated circuits by depositing semiconductor materials (for example, on a wafer that may include a mask), removing materials, changing a shape of a deposited material, modifying materials (for example, by doping materials or modifying a dielectric constant using UV treatment), and the like. An integrated circuit may include transistors, and may further include other circuit elements (for example, passive elements such as a capacitor, a resistor, and an inductor) and interconnection between the transistors and circuit elements.

FIG. 7 is a schematic exemplary diagram of an operation chip and a computing device in accordance with embodiments of the present disclosure.

In accordance with embodiments of the present disclosure, an operation chip is further provided. Referring to FIG. 7, an operation chip 704 includes at least one integrated circuit 702 described above. In some embodiments, the operation chip 704 may include both the integrated circuit 702 that includes the first standard cell and the second standard cell and that adjusts the standard layouts of the standard cells to reduce the layout area described above, and other digital integrated circuits or analog integrated circuits entirely using standard layouts without the adjustment. The operation chip 704 may be configured to implement relatively complex computing functions, for example, implementing a specific algorithm (for example, a hash algorithm). A person skilled in the art should understand that although the operation chip 704 shown in FIG. 7 is a part of the computing device 700, the operation chip 704 may be alternatively used alone as a separate component.

In accordance with embodiments of the present disclosure, a computing device is further provided. The computing device may be configured to execute an algorithm for mining virtual digital currency. Referring to FIG. 7, the computing device 700 may include: at least one operation chip 704 described above; a control chip 706; a power supply module 708; and a heat dissipater 710. The control chip 706 is coupled to the at least one operation chip 704. The power supply module 708 may be configured to provide power to the at least one operation chip 704 and the control chip 706. The heat dissipater 710 may be configured to dissipate heat for the at least one operation chip 704, the control chip 706, and/or the power supply module 708. In some embodiments, the computing device 700 may be configured to, for example, execute a hash algorithm for mining bitcoins.

The flowcharts and block diagrams in the accompanying drawings illustrate architectures, functions, and operations of that may be implemented by the method according to the embodiments of the present disclosure. In some implementations used as substitutes, functions marked in blocks may alternatively occur in a sequence different from that marked in an accompanying drawing. For example, depending on functions involved, two blocks shown in succession may be actually executed substantially in parallel, or the blocks may sometimes be executed in the reverse order. It should be further noted that each block in the block diagrams and/or the flowcharts, and combinations of blocks in the block diagrams and/or the flowcharts may be implemented by a special-purpose or general-purpose hardware-based system that performs a specified function or behavior or performs a combination of special-purpose or general-purpose hardware and computer instructions.

In all examples shown and discussed herein, any specific value should be construed as illustrative only and not as limiting. Therefore, other examples of the exemplary embodiments may have different values.

As used herein, the term “exemplary” means “serving as an example, instance, or illustration” rather than as a “model” to be exactly reproduced. Any implementation exemplarily described herein is not necessarily to be illustrated as preferred or advantageous over other implementations. Moreover, the present disclosure is not limited to any expressed or implied theory provided in the technical field, the background, the summary, or the detailed description.

In addition, the descriptions herein may refer to elements or features being “connected”. As used herein, unless expressly stated otherwise, “connected” means that one element/node/feature is electrically, mechanically, logically, or otherwise directly connected to (or in direct communication with) another element/node/feature.

In addition, the terms such as “first” and “second” may be further used herein for reference purposes only, and are thus not intended to be limiting. For example, unless clearly specified in the context, the terms “first” and “second”, and other numerical terms referring to structures or elements do not imply a sequence or order.

It should be further understood that the term “include”, when used herein, indicates the presence of stated features, integers, steps, operations, units, and/or components, but does not exclude the presence or addition of one or more other features, integers, steps, operations, units, and/or components, and/or combinations thereof.

Although some specific embodiments of the present disclosure are shown in detail through examples, a person skilled in the art should understand that the foregoing examples are intended to be illustrative only and not to limit the scope of the present disclosure. A person skilled in the art should understand that the foregoing embodiments may be modified without departing from the scope and spirit of the present disclosure. The scope of the present disclosure is defined by the appended claims.

1. A method, comprising:
generating a primary layout based on a circuit diagram netlist using a primary standard cell library, the circuit diagram netlist comprising a first standard cell and a second standard cell, and the primary standard cell library comprising a first standard layout of the first standard cell and a second standard layout of the second standard cell; and
consolidating the first standard layout and the second standard layout based on a splicing relationship between the first standard layout and the second standard layout in the primary layout to optimize the consolidated layout.

2. The method according to claim 1, wherein the second standard layout is a standard layout in the primary layout that has a frequency of splicing with the first standard layout higher than a reference value.

3. The method according to claim 1, wherein a layout area of at least one standard layout of the first standard layout or the second standard layout is greater than a theoretical minimum of the layout area of the at least one standard layout, and the consolidating the first standard layout and the second standard layout to optimize the consolidated layout comprises: reducing an area of the consolidated layout of the first standard layout and the second standard layout.

4. The method according to claim 3, wherein the consolidating the first standard layout and the second standard layout to optimize the consolidated layout comprises:
identifying a potentially optimizable region in the at least one standard layout of the first standard layout or the second standard layout;
determining, based on the splicing relationship between the first standard layout and the second standard layout, whether the first standard layout and the second standard layout have restrictions on the potentially optimizable region;
determining, in response to determining that the first standard layout and the second standard layout have no restrictions on the potentially optimizable region, that the potentially optimizable region is an optimizable region; and
adjusting a layout of the at least one standard layout comprising the optimizable region to reduce an area of the optimizable region.

5. The method according to claim 3, wherein the at least one standard layout is implemented based on MOS transistors, and the consolidating the first standard layout and the second standard layout to optimize the consolidated layout comprises: transferring connection relationships on redundant gate polysilicon in the at least one standard layout to other appropriate gate polysilicon and removing the redundant gate polysilicon.

6. The method according to claim 1, wherein the consolidating the first standard layout and the second standard layout to optimize a consolidated layout comprises: reducing lengths of interconnections in subsequent routing.

7. The method according to claim 6, wherein the reducing the lengths of interconnections in subsequent routing further comprises:
adjusting interconnections between the first standard layout and the second standard layout that is obtained through automatic routing and that is at a different metal layer from interconnections in the first standard layout or the second standard layout to a same metal layer as the interconnections in the first standard layout or the second standard layout.

8. The method according to claim 1, further comprising:
splitting the optimized consolidated layout into a first optimized layout for the first standard cell and a second optimized layout for the second standard cell; and
adding the first optimized layout and the second optimized layout to the primary standard cell library to form an optimized standard cell library.

9. The method according to claim 8, wherein the first optimized layout comprises information for indicating that the first optimized layout needs to be used in combination with the second optimized layout in a layout design, and the second optimized layout comprises information for indicating that the second optimized layout needs to be used in combination with the first optimized layout in a layout design.

10. The method according to claim 1, wherein the first standard layout, the second standard layout, and the optimized consolidated layout meet process design rules.

11. An integrated circuit, comprising:
a first standard cell; and
a second standard cell, wherein a first layout of the first standard cell and a second layout of the second standard cell have a splicing relationship, the first layout is obtained by adjusting a layout of a first standard layout of the first standard cell in a primary standard cell library, and the second layout is a second standard layout of the second standard cell in the primary standard cell library or is obtained by adjusting a layout of the second standard layout of the second standard cell in the primary standard cell library, such that a sum of areas of the first layout and the second layout is less than a sum of areas of the first standard layout and the second standard layout.

12. The integrated circuit according to claim 11, wherein the first standard cell and the second standard cell are implemented based on CMOS transistors, the first layout is obtained by transferring connection relationships on redundant gate polysilicon in the first standard layout to other appropriate gate polysilicon in the first standard layout and removing the redundant gate polysilicon in the first standard layout, and the second layout is the second standard layout or is obtained by transferring connection relationships on redundant gate polysilicon in the second standard layout to other appropriate gate polysilicon in the second standard layout and removing the redundant gate polysilicon in the second standard layout.

13. The integrated circuit according to claim 12, wherein the first standard cell and the second standard cell are two-input Exclusive-OR gates (XOR2s), and the integrated circuit is an adder circuit.

14. A operation chip, comprising at least one integrated circuit comprising:
a first standard cell; and
a second standard cell, wherein a first layout of the first standard cell and a second layout of the second standard cell have a splicing relationship, the first layout is obtained by adjusting a layout of a first standard layout of the first standard cell in a primary standard cell library, and the second layout is a second standard layout of the second standard cell in the primary standard cell library or is obtained by adjusting a layout of the second standard layout of the second standard cell in the primary standard cell library, such that a sum of areas of the first layout and the second layout is less than a sum of areas of the first standard layout and the second standard layout.

15. A computing device, configured to execute an algorithm for mining virtual digital currency, the computer device comprising:
at least one operation chip according to claim 14;
a control chip;
a power supply module; and
a heat dissipater, wherein
the control chip is coupled to the at least one operation chip and configured to control an operation of the at least one operation chip,
the power supply module is configured to provide power to the at least one operation chip and/or the control chip, and
the heat dissipater is configured to dissipate heat for the at least one operation chip, the control chip, and/or the power supply module.

16. The operation chip according to claim 14, wherein the first standard cell and the second standard cell are implemented based on CMOS transistors, the first layout is obtained by transferring connection relationships on redundant gate polysilicon in the first standard layout to other appropriate gate polysilicon in the first standard layout and removing the redundant gate polysilicon in the first standard layout, and the second layout is the second standard layout or is obtained by transferring connection relationships on redundant gate polysilicon in the second standard layout to other appropriate gate polysilicon in the second standard layout and removing the redundant gate polysilicon in the second standard layout.

17. The operation chip according to claim 16, wherein the first standard cell and the second standard cell are two-input Exclusive-OR gates (XOR2s), and the integrated circuit is an adder circuit.

18. The integrated circuit according to claim 12, wherein the redundant gate polysilicon in the first standard layout and in the second standard layout is different from a dummy polysilicon used as an isolation boundary.

19. The method according to claim 1, further comprising:
analyzing whether a splicing relationship exists among all standard layouts including the first standard layout and the second standard layout in the primary layout and computing statistics on frequencies of splicing between standard layouts.

20. The method according to claim 19, wherein the consolidating the first standard layout and the second standard layout is in response to determining the splicing relationship between the first standard layout and the second standard layout in the primary layout and determining that the second standard layout is a standard layout in the primary layout that has a frequency of splicing with the first standard layout higher than frequencies of splicing the first standard layout with standard layouts in the primary layout other than the first and second standard layouts.
